(19) United States
(12) Patent Application Publication
(10) Pub. No.: US 2009/0079744 A1
(43) Pub. Date: Mar. 26, 2009

(54) ANIMATING OBJECTS USING A DECLARATIVE ANIMATION SCHEME

(75) Inventors: Crystal Rhan-Tsor Chen, Sunnyvale, CA (US); Barn-Wan Li, San Jose, CA (US); Jeffrey Chao-Nan Chen, Mountain View, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/859,090

(22) Filed: Sep. 21, 2007

(51) Int. Cl. G06T 15/70

(52) U.S. Cl. 345/473

(57) ABSTRACT

Technologies are described herein for animating objects through the use of animation schemes. An animation scheme is defined using a declarative language that includes instructions defining the animations and/or visual effects to be applied to one or more objects and how the animations or visual effects should be applied. The animation scheme may include rules which, when evaluated, define how the objects are to be animated. An animation scheme engine is also provided for evaluating an animation scheme along with other factors to apply the appropriate animation to each of the objects. The animation scheme engine retrieves an animation scheme and data regarding the objects. The animation scheme engine then evaluates the animation scheme along with the data regarding the objects to identify the animation to be applied to each object. The identified animations and visual effects are then applied to the objects.

### BACKGROUND

Presentation application programs provide functionality for creating and delivering audiovisual presentations. Typically, presentations take the form of one or more presentation slides. Each presentation slide can include numerous objects, such as text, photographs, lists, tables, charts, shapes, clip art, sound clips, movies, and others. Presentations can be displayed on-screen and navigated through at the command of a user in order to deliver the presentation.

Many presentation application programs provide functionality for animating and applying visual effects to the objects on each presentation slide and for animating and applying visual effects to the transitions between presentation slides. For instance, using the functionality provided by typical presentation application programs, a user could define a path of motion over time (a “motion path”) for an object on a presentation slide. When the presentation slide is displayed, the presentation application program will cause the object to be animated along the defined motion path. A user may manually apply other types of animation properties to a presentation object in a similar manner.

The animation functionality provided by presentation application programs has traditionally been limited in several ways. For instance, animation functionality has typically been limited to the separate application of a static set of animation properties to each object in a presentation, such as the application of a motion path to an object in the manner described above. As a result, it has generally been time-consuming using previous presentation application programs for a user to choreograph the animation of multiple objects on a presentation slide in a visually appealing manner.

It is with respect to these considerations and others that the disclosure made herein is presented.

### SUMMARY

Technologies are described herein for animating objects through the use of animation schemes. In particular, through the utilization of the technologies and concepts presented herein, an animation scheme can be declaratively defined that includes instructions for choreographing the animation of multiple objects. Moreover, through the technologies provided herein, animations can be defined that are dependent upon the number of objects to be animated, the position of the objects, the type of objects, or other factors. Because a declarative language is utilized to define the animations, users less familiar with programming can easily edit animation schemes or define new animation schemes. The animation schemes may also be easily added to the animation schemes made available by an application program.

According to one aspect presented herein, an animation scheme is defined using a declarative language. The animation scheme includes instructions that define the animations and/or visual effects that should be applied to one or more objects and how the animations or visual effects should be applied. For instance, in one implementation, the animation scheme includes data identifying the animations that should be applied to each object along with data indicating whether the objects should be animated sequentially or concurrently.

In one embodiment, the animation scheme includes rules which, when evaluated, define how the objects are to be animated. For instance, rules may be specified for causing the objects to be animated differently depending upon the number of objects, the type of objects, the position of objects, or other factors. In one implementation, the declarative language utilized to define the animation scheme is the extensible markup language (“XML”). It should be appreciated, however, that other declarative languages and data formats might also be utilized to define the animation scheme.

According to other aspects, an animation scheme engine is provided for evaluating an animation scheme along with other factors to apply the appropriate animation to each of the objects. In particular, in one embodiment the animation scheme engine retrieves an animation scheme to be applied to one or more objects. The animation scheme engine also retrieves data regarding the objects. The data regarding the objects may include data regarding the location of each of the objects, the type of the objects, the quantity of objects, or other environmental variables. The animation scheme engine then evaluates the animation scheme along with the data regarding the objects to determine the animation to be applied to each object. Once the animation scheme engine has determined the animations and visual effects to be applied to each object, the animations and visual effects are applied to the objects. Other effects, such as transitions or sounds may also be defined and applied in a similar manner.

It should also be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a software architecture diagram illustrating aspects of a presentation application provided in one implementation presented herein;

FIG. 2 is a data structure diagram showing aspects of an animation scheme data structure provided in one implementation presented herein;

FIG. 3 is a screen diagram showing a presentation slide having several objects displayed thereon that have been animated by an animation scheme engine provided herein;

FIG. 4 is a flow diagram showing an illustrative process for animating objects using an animation scheme in one implementation described herein; and

FIG. 5 is a computer architecture diagram showing an illustrative computer hardware and software architecture for a computing system capable of implementing the embodiments presented herein.

### DETAILED DESCRIPTION

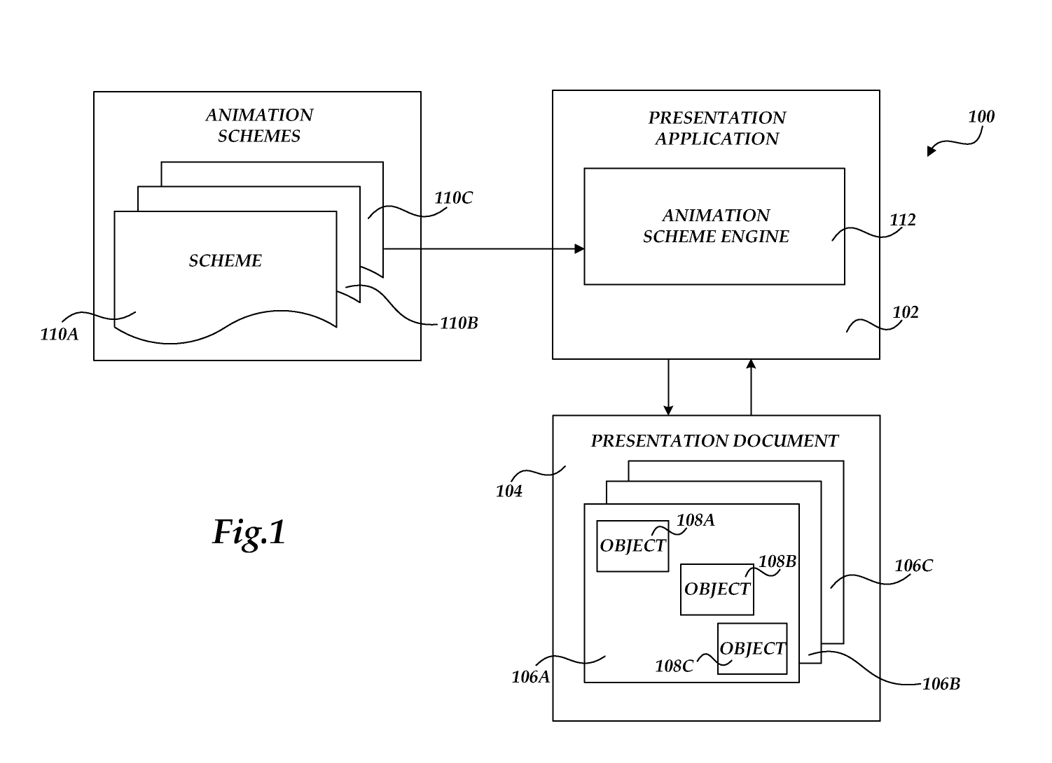

The following detailed description is directed to technologies for animating objects. Through the use of the embodiments presented herein, the application of animations and visual effects to objects can be choreographed through the creation of an animation scheme. The animation scheme may be created through the use of a declarative language, such as XML, and contains rules and instructions regarding how the animations and visual effects should be applied to one or more objects. An application program that embodies the concepts and technologies presented herein utilizes the animation scheme to animate and apply visual effects to the objects. Additional details regarding the various embodiments presented herein will be presented below with reference to FIGS. 1-5.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for laying out images and associated text will be described.

Turning now to FIG. 1, details will be provided regarding one embodiment presented herein for animating objects. In particular, FIG. 1 illustrates aspects of a software architecture 100 utilized to animate objects according to one implementation. As shown in FIG. 1, the embodiments presented herein are described in the context of a presentation application program 102. The presentation application 102 provides functionality for creating and delivering audiovisual presentations. Typically, presentations take the form of one or more presentation slides 106A-106C contained within a presentation document 104. Each of the presentation slides 106A-106C can include numerous audiovisual objects 108A-108C. The objects 108A-108C comprise any type of audiovisual component that may be used in a presentation, such as text, photographs, lists, tables, charts, shapes, clip art, sounds clips, and movies. Other types of audiovisual objects may also be utilized. The presentation slides 106A-106C can be displayed on a computer display screen and navigated through at the command of a user in order to deliver the presentation.

As described herein, the presentation application 102 also includes functionality for animating and applying visual effects to the objects 108A-108C and to transitions between the presentation slides 106A-106C. In this regard, the presentation application 102 includes an animation scheme engine 112. As will be described in greater detail below, the animation scheme engine 112 is operative to determine the animations and visual effects to be applied to the objects 108A-108C on each of the presentation slide 106A-106C using the contents of an animation scheme 110A.

As shown in FIG. 1, one or more animation schemes 110A-110C may be defined and stored for use in conjunction with the presentation application 102. The presentation application 102 may provide a user interface that allows a user to choose which of the available animation schemes 110A-110C is to be applied to each of the presentation slides 106A-106C in the presentation document 104. A different animation scheme 110A-110C may be applied to each of the slides 106A-106C. Functionality may also be provided for allowing a user to edit the animation schemes 110A-110C and to add new animation schemes. In one embodiment, the animation schemes 110A-110C are utilized in conjunction with visual themes. Themes define visual styles for objects within the presentation slides 106A-106C, such as the color palette that should be utilized or the manner in which text should be formatted. In this way, the animation of the objects 108A-108C on a presentation slide 106A may be performed in a manner that is consistent with the visual style of the slide 106A.

As will be described in greater detail below, the animation schemes 110A-110C may be defined using a declarative language, such as XML. Other types of declarative languages may also be similarly utilized. The animation schemes 110A-110C include instructions specified using the declarative language that define the animations and/or visual effects that should be applied to the objects 108A-108C and how the animations or visual effects should be applied. For instance, in one implementation, the animation schemes 110A-110C include data identifying the animations that should be applied to each of the objects 106A-106C along with data indicating whether the objects 108A-108C should be animated sequentially or concurrently. As another example, an animation scheme 110A may be defined that specifies that a rotation animation should be applied to an object 108A and that specifies the degree of rotation. Alternatively, an animation scheme 110A may specify a motion path that an object 108A should follow. The animations defined within each animation scheme 110 may also be stacked together, thereby permitting complex animations made up of combined effects.

In one embodiment, the animation schemes 110A-110C include rules which, when evaluated, define how the objects 106A-106C are to be animated. For instance, rules may be specified for causing the objects to be animated differently depending upon the number of objects 108A-108C. As an example, one set of animations may be defined for the case where there are two objects 108A-108B on the slide 106A while another animation is defined for the case where there are three objects 108A-108C on the slide 106A.

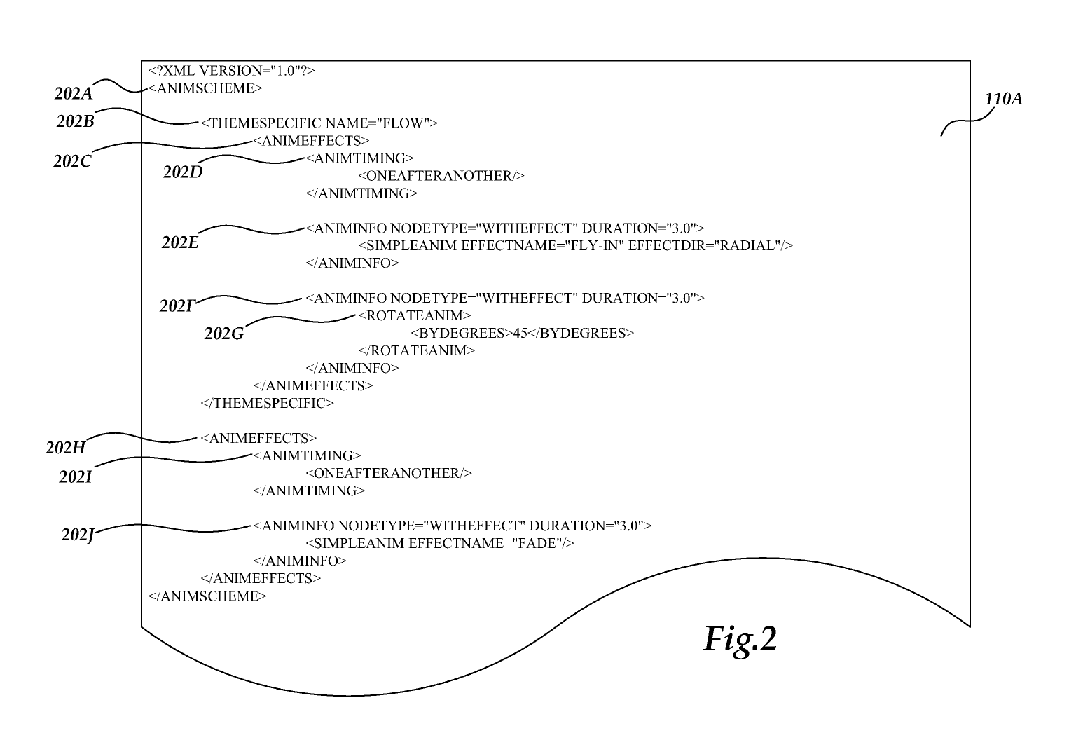

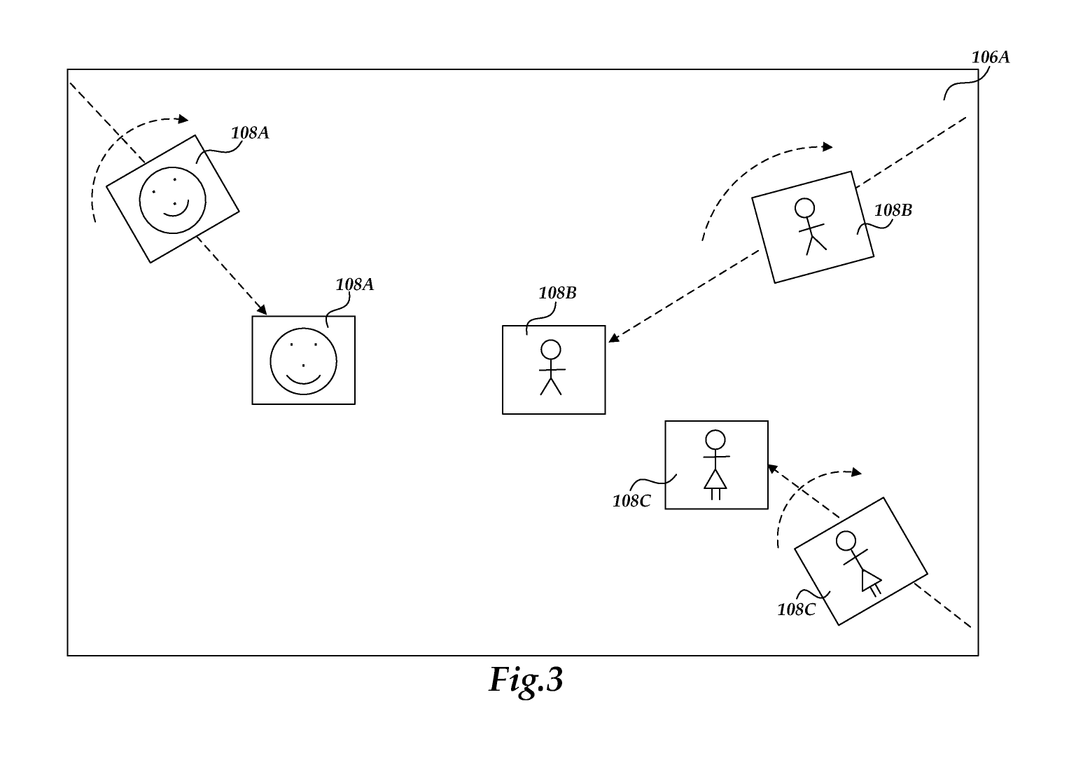

According to another aspect, a rule may be specified that alters the type of animation that is applied based on the type of the objects 108A-108C. For instance, a rule may specify that one animation is to be applied to a text object while another animation is to be applied to an image object. In another implementation, a rule may be specified that animates the objects 108A-108C differently depending upon the position of objects 108A-108C on the slide 106A. For instance, as will be discussed below with respect to FIGS. 2-3, an animation may be defined that moves each of the objects 108A-108C onto the slide 106A from a direction that is dependent upon the final resting place of the objects 108A-108C on the slide 106A. It should be appreciated that other types of rules may be declaratively defined within the animation schemes 110A-110C.

As will be discussed in greater detail below, the animation scheme engine 112 utilizes an animation scheme 110A and data from the presentation document 104 to determine how the objects 108A-108C are to be animated in one embodiment. For instance, the animation scheme engine 112 may retrieve data identifying the type of objects 108A-108C on the slide 106A, the number of objects 108A-108C on the slide 106A, and the position of the objects 108A-108C on the slide 106A. The animation scheme engine 112 utilizes this information to evaluate the rules set forth in the appropriate animation scheme 110A to determine the animations that should be applied to each of the objects 108A-108C. Once the proper animations have been identified, the animations can be applied to the objects 108A-108C. Additional details regarding this process are provided below with respect to FIG. 2.

Referring now to FIG. 2, an illustrative animation scheme 110A will be described. The illustrative animation scheme 110A shown in FIG. 2 utilizes XML to define the rules and animations to be applied to the objects 108A-108C. The illustrative animation scheme 110A shown in FIG. 2 also specifies the animations to be applied to image objects. It should be appreciated, however, the similar concepts may be utilized to specify the animations and visual effects to be applied to other types of objects.

As shown in FIG. 2, the animation scheme 110A includes a <ANIMSCHEME> tag 202A that encompasses the other tags making up the animation scheme 110A. In the illustrative animation scheme 110, two sets of animations have been defined. The particular set of animations that will be applied to the objects 108A-108C depends on whether a theme has been applied. As discussed above, a theme defines a visual style for the objects in a presentation. This is accomplished through the use of the <THEMESPECIFIC> tag 202B. If a theme entitled “FLOW” has been applied, the animation defined within the <THEMESPECIFIC> tag 202B will be utilized. Otherwise, the animation defined within the <ANIMEFFECTS> tag 202H will be utilized.

The <THEMESPECIFIC> tag 202b encompasses a <ANIMEFFECTS> tag 202C that defines the animation. A <ANIMTIMING> tag 202D is also defined that specifies the timing sequence that should be utilized for performing the defined animations. In the example shown in FIG. 2, the <ANIMTIMING> tag 202D specifies that the animations should be applied to each of the objects 108A-108C such that the objects animate sequentially. It should be appreciated, however, that the animations maybe applied concurrently, or in another manner.

The illustrative animation scheme 110A shown in FIG. 2 also includes several <ANIMINFO> tags 202E and 202F. Each of these tags describe an animation that should be applied to each of the objects 108A-108C. For instance, the <ANIMINFO> tag 202E in conjunction with an encompassed <SIMPLEANIM> tag defines a radial “fly-in” animation by which each of the objects 108A-108C moves onto the slide 106A from a direction that depends upon the final location of the objects 108A-108C on the slide 106A. The NODETYPE=WITHEFFECT attribute of the <ANIMINFO> tag 202E indicates that the radial “fly-in” animation should be performed at the same time as any other animations that have been defined. The DURATION=3.0 attribute indicates that the animation specified by the <ANIMINFO> tag 202E should be performed for three seconds.

The <ANIMINFO> tag 202F in conjunction with the encompassed <ROTATEANIM> and <BYDEGREES> tags define a rotation animation by which each of the objects 108A-108C is rotated 45 degrees. The NODETYPE=WITHEFFECT attribute of the <ANIMINFO> tag 202F indicates that the rotation animation should be performed at the same time as any other animations that have been defined. The DURATION=3.0 attribute indicates that the animation specified by the <ANIMINFO> tag 202F should be performed for three seconds.

As discussed above, if a theme entitled “FLOW” has not been applied, the animations defined by the <ANIMEFFECTS> tag 202H will be utilized to animate the objects 108A-108C. In this case, the <ANIMTIMING> tag 2021 specifies that the animations should be applied to each of the objects 108A-108C such that the objects animate sequentially. The <ANIMINFO> tag 202J and the encompassed <ANIMINFO> tag indicate that the objects should be faded in over a period of three seconds. It should be appreciated that the animation scheme 110A is merely illustrative and that other schemas may be utilized to declaratively define rules governing how the objects 108A-108C are to be animated.

Turning now to FIG. 3, an illustrative screen display will be described showing the application of the animation scheme 110A shown in FIG. 2 and described above to a presentation slide 106A that includes three objects 108A-108C. As discussed above with respect to FIG. 2, the animation scheme 110A defines a radial “fly-in” animation that depends upon the final location of the objects 108A-108C on the slide 106A and a rotation animation when a theme entitled “FLOW” has been applied. FIG. 2 illustrates the animation of the objects 108A-108C as a result of the XML instructions within the animation scheme 110A where a theme entitled “FLOW” has been applied. In particular, the object 108A is animated along a motion path from the upper-left corner of the slide 106A to its final location. It is also rotated 45 degrees while it is animated along the motion path. The object 108B is animated along a motion path from the upper-right corner of the slide 106A to its final location. The object 108B is also rotated 45 degrees while it is animated along the motion path. The object 108C is animated along a motion path from the lower-right corner of the slide 106A to its final location. The object 108C is also rotated 45 degrees while it is animated along the motion path. It should be appreciated that this example is merely illustrative and that other types of animations may be defined and applied to the objects 108A-108C.

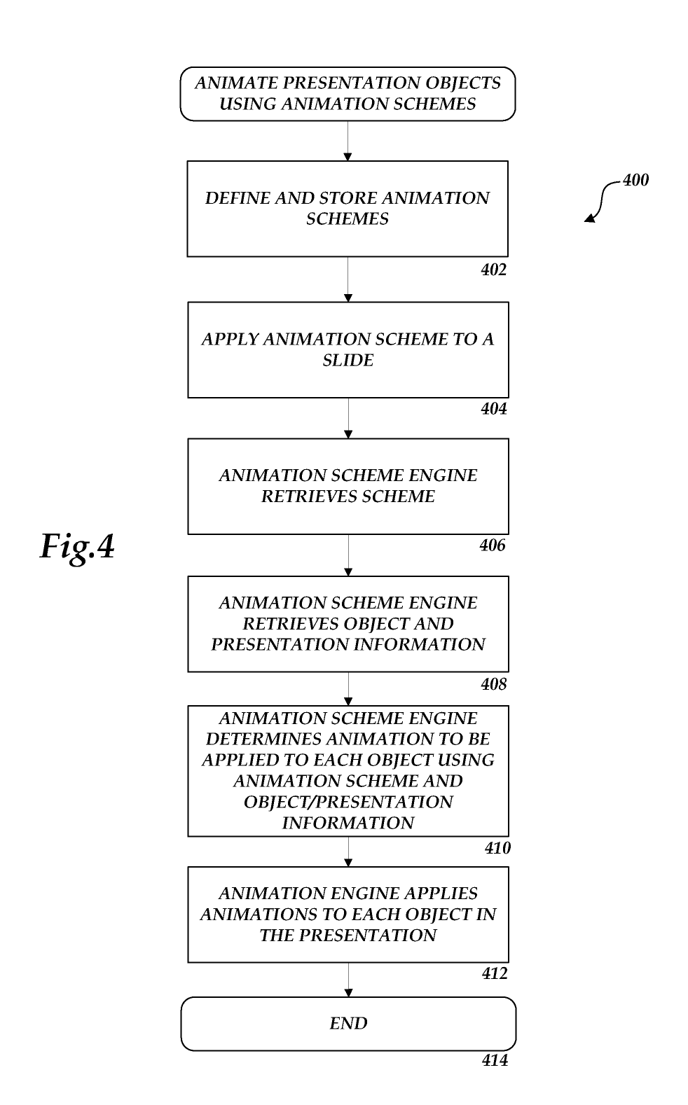

Referring now to FIG. 4, additional details will be provided regarding the embodiments presented herein for animating objects. In particular, FIG. 4 shows a flow diagram describing a routine 400 for animating the objects 108 using an animation scheme 110. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 400 begins at operation 402, where the animation schemes 110A-110C are defined and stored. As discussed briefly above, because the animation schemes 110A-110C are specified using a declarative language, a designer can easily define new animations and store them in a location accessible to the animation scheme engine 112. Animation schemes 110A-110C may also be easily customized in a similar manner.

From operation 402, the routine 400 continues to operation 404 where an animation scheme 110A is applied to a slide 106 within a presentation document 104. This may occur, for instance, in response to a user request to apply the animation scheme 110A to a slide 106A. In order to apply the animation scheme 110A to the slide 106A, the routine 400 continues to operation 406, where the animation scheme engine 112 retrieves the animation scheme 110A. The routine 400 then continues to operation 408, where the animation scheme engine 112 retrieves information regarding the presentation document 104 and the objects 108A-108C necessary to evaluate the contents of the animation scheme 110A. For instance, as described above, the animation scheme engine 112 may retrieve data regarding the number and type of the objects 108A-108C or the location of the objects 108A-108C on the slide 106A.

At operation 410, the animation scheme engine 112 uses the retrieved information regarding the presentation document 104 and the objects 108A-108C to evaluate the rules contained in the animation scheme 110A and determine the animations and visual effects that should be applied to each of the objects 108A-108C. Once the animations to be applied to each of the objects 108A-108C have been identified, the routine 400 then continues to operation 412 where the identified animations are applied to each of the objects 108A-108C. Once the animations have been applied to the objects 108A-108C, the routine 400 continues to operation 414, where it ends.

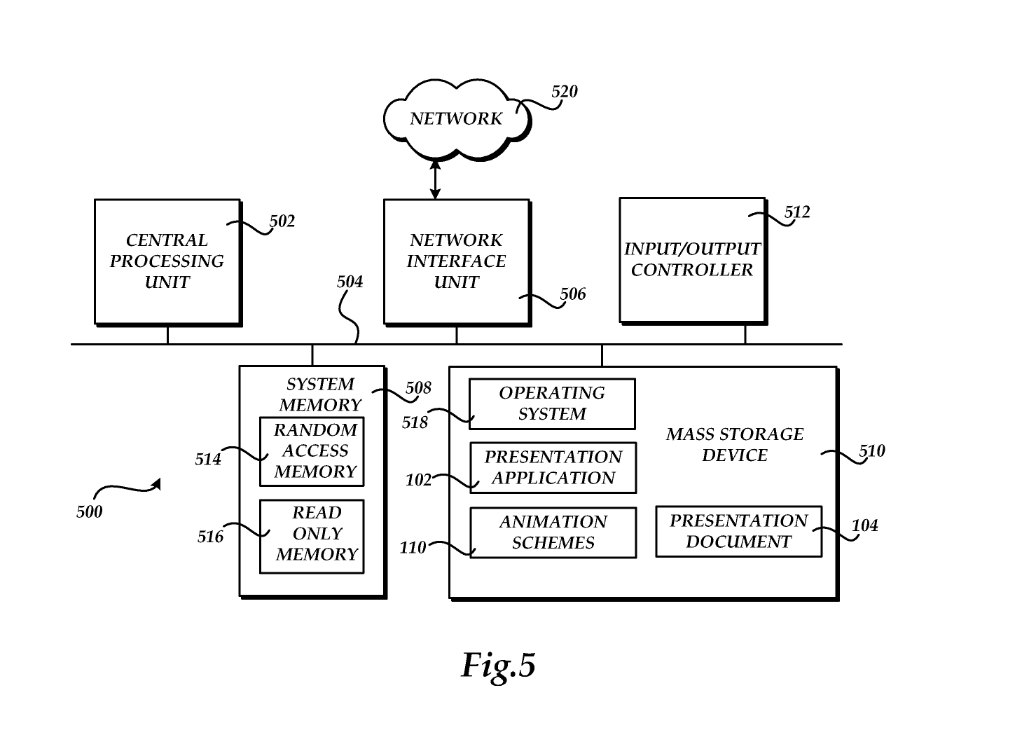

FIG. 5 shows an illustrative computer architecture for a computer 500 capable of executing the software components described herein for animating objects using animation schemes in the manner presented above. The computer architecture shown in FIG. 5 illustrates a conventional desktop, laptop, or server computer and may be utilized to execute any aspects of the presentation application 102 described herein. As mentioned above, the computer 500 may also execute other types of application programs that embody the concepts presented herein for animating objects using animation schemes.

The computer architecture shown in FIG. 5 includes a central processing unit 502 (“CPU”), a system memory 508, including a random access memory 514 (“RAM”) and a read-only memory (“ROM”) 516, and a system bus 504 that couples the memory to the CPU 502. A basic input/output system containing the basic routines that help to transfer information between elements within the computer 500, such as during startup, is stored in the ROM 516. The computer 500 further includes a mass storage device 510 for storing an operating system 518, application programs, and other program modules, which will be described in greater detail below.

The mass storage device 510 is connected to the CPU 502 through a mass storage controller (not shown) connected to the bus 504. The mass storage device 510 and its associated computer-readable media provide non-volatile storage for the computer 500. Although the description of computer-readable media contained herein refers to a mass storage device, such as a hard disk or CD-ROM drive, it should be appreciated by those skilled in the art that computer-readable media can be any available computer storage media that can be accessed by the computer 500.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 500.

According to various embodiments, the computer 500 may operate in a networked environment using logical connections to remote computers through a network such as the network 520. The computer 500 may connect to the network 520 through a network interface unit 506 connected to the bus 504. It should be appreciated that the network interface unit 506 may also be utilized to connect to other types of networks and remote computer systems. The computer 500 may also include an input/output controller 512 for receiving and processing input from a number of other devices, including a keyboard, mouse, or electronic stylus (not shown in FIG. 5). Similarly, an input/output controller may provide output to a display screen, a printer, or other type of output device (also not shown in FIG. 5).

As mentioned briefly above, a number of program modules and data files may be stored in the mass storage device 510 and RAM 514 of the computer 500, including an operating system 518 suitable for controlling the operation of a networked desktop, laptop, or server computer. The mass storage device 510 and RAM 514 may also store one or more program modules. In particular, the mass storage device 510 and the RAM 514 may store a presentation application 102 that provides the functionality described herein for animating objects using an animation scheme. The mass storage device 510 and RAM 514 may also store the animation schemes 110 and a presentation document 104, both of which have been described above.

Based on the foregoing, it should be appreciated that technologies for animating objects using an animation scheme are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for animating one or more objects using an animation scheme, the method comprising:
storing data defining the animation scheme;
associating the animation scheme with the one or more objects;
retrieving data regarding the one or more objects; and
animating the one or more objects based on the data defining the animation scheme and the data regarding the one or more objects.

2. The method of claim 1, wherein the data defining the animation scheme is expressed using a declarative language.

3. The method of claim 1, wherein the data defining the animation scheme expresses one or more rules regarding how the one or more objects should be animated.

4. The method of claim 1, wherein the data defining the animation scheme indicates whether the one or more objects should be animated sequentially or concurrently.

5. The method of claim 1, wherein the data defining the animation scheme specifies one or more animations or visual effects that should be applied to each of the one or more objects.

6. The method of claim 1, wherein the data regarding the one or more objects comprises a location for each of the one or more objects.

7. The method of claim 1, wherein the data regarding the one or more objects comprises a type for each of the one or more objects.

8. The method of claim 1, wherein the data regarding the one or more objects comprises the quantity of the one or more objects.

9. A computer-readable medium having computer-executable instructions stored thereon which, when executed by a computer, cause the computer to perform the method of claim 1.

10. A method for animating one or more objects on a slide in a slide presentation using an animation scheme, the method comprising:
storing an animation scheme, the animation scheme being expressed using a declarative markup language;
associating the animation scheme with the one or more objects on the slide; and
executing an animation scheme engine, the animation scheme engine operative to retrieve data regarding the one or more objects on the slide and to utilize the animation scheme and the data regarding the one or more objects on the slide to generate an animation for the one or more objects.

11. The method of claim 10, wherein the animation scheme expresses a rule defining how the one or more objects should be animated.

12. The method of claim 11, wherein the animation scheme defines one or more animations or visual effects that should be applied to each of the one or more objects.

13. The method of claim 11, wherein the animation scheme engine is executed by a presentation application program.

14. The method of claim 13, wherein the data regarding the one or more objects comprises a location for each of the one or more objects.

15. The method of claim 14, wherein the data regarding the one or more objects further comprises a type for each of the one or more objects.

16. The method of claim 15, wherein the data regarding the one or more objects further comprises the quantity of the one or more objects.

17. A computer-readable medium having computer-executable instructions stored thereon which, when executed by a computer, cause the computer to perform the method of claim 10.

18. A computer-readable media having a data structure stored thereon for use by an animation scheme engine in generating an animation to be applied to one or more objects, the data structure comprising:
a first data field expressed using a declarative markup language, the first data field storing data defining a rule indicating how the one or more objects should be animated; and
a second data field expressed using the declarative markup language, the second data field storing data defining an animation to be applied to the one or more objects in the event that the rule is satisfied, and wherein the data stored in the first data field and the data stored in the second data field are utilized by the animation scheme engine in generating the animation for the one or more objects.

19. The computer-readable media of claim 18, wherein the data structure further comprises a third data field expressed using the declarative markup language, the third data field storing data indicating whether the animation should be applied to each of the one or more objects sequentially or concurrently.

20. The computer-readable media of claim 18, wherein the one or more objects comprise objects in a slide presentation.
